(19) United States
(12) Patent Application Publication
(10) Pub. No.: US 2026/0191207 A1
(43) Pub. Date: Jul. 9, 2026

(54) IMPROVEMENTS TO A METHOD FOR EXTRACTING AN ACTIVE ACID EXTRACT FROM AGRICULTURAL HUSKS AND ITS USE TO PROMOTE PLANT GROWTH AND DEVELOPMENT UNDER NORMAL CONDITIONS OR UNDER ABIOTIC STRESS

(71) Applicant: INNOVAK GLOBAL, S.A. DE C.V., Chihuahua (MX)

(72) Inventors: Ali Jesus ASAFF TORRES, Chihuahua (MX); Francisco Javier DE LA TORRE GONZALEZ, Chihuahua (MX); Alberto ORMAZABAL ARRAYA, Chihuahua (MX)

(21) Appl. No.: 19/130,702

(22) PCT Filed: Aug. 29, 2024
(86) PCT No.: PCT/MX2024/050043

§ 371 Date: May 16, 2025

(30) Foreign Application Priority Data
Sep. 8, 2023 (MX) MX/A/2023/010644

(51) Int. Cl. A01N 65/44; A01N 25/02; A01N 37/44

(52) U.S. Cl. CPC A01N 65/44; A01N 25/02; A01N 37/44

(57) ABSTRACT

for An improved method for producing an active acid extract from agricultural husks, particularly from rice or oat husks, and the use thereof for promoting plant growth and development under normal conditions or under abiotic stress, particularly saline stress including the use of effective doses of said active acid extract, either alone or formulated with glycine betaine. The improvement made to the method lies in the implementation of the adsorption or retention phase, the purification phase and the desorption phase. The resulting active acid extract is used in both monocotyledon and dicotyledon plants.

### TECHNICAL FIELD OF THE INVENTION

The present invention relates to improvements to a method of extracting an active acid extract from agricultural husks, particularly from rice or oat husks, and its use to promote plant growth and development under normal conditions or under abiotic stress, particularly saline stress, and which comprise the application of effective doses of said active acid extract, alone or formulated with glycine betaine.

### BACKGROUND OF THE INVENTION

Demand for food has risen dramatically due to rapid global population growth over the past 20 years (Savary et al., Food Secur. 2020, 12, 695-717) so the improvement in crop yield and quality is a global, highly priority issue that must be addressed, although to do so a series of obstacles must be overcome, many of them related to abiotic stress in plants and exacerbated by climate change. Among these, soil salinization is the greatest environmental challenge threatening global agriculture (Hazell et al., Philos. Trans. R. Soc. B Biol. Sci. 2007, 363, 495-515) since it is estimated that approximately 20% of irrigated agricultural lands worldwide are adversely affected by soil salinization (Qadir et al., Nat. Resour. Forum 2014, 38, 282-295). Salinization problems are aggravated by environmental degradation, poor irrigation practices and climate change (Park et al., Mol. Cells 2016, 39, 447-459; Ziska et al., Proc. R. Soc. B Boil. Sci. 2012, 279, 4097-4105). Given this scenario, the development of new tools that help increase crop yield and quality is critical, mitigating the effects of growing threats such as various types of abiotic stress, primarily resulting from climate change, soil salinization, and poor agricultural practices.

Stress is defined as a physiological reaction of an organism in which various response mechanisms come into play to cope with a situation that is perceived as threatening or of increased demand. Any unfavorable substance or condition that affects or blocks plant metabolism, growth, or development is considered a stress factor. In plants, stress signals evolved from energy quantification, promoting ion and water homeostasis, as well as cellular stability under stress conditions. In plants, SnRK regulators are responsible for stopping various processes, such as cell division and therefore normal plant development. In contrast, the TOR regulator is an activator of different functions and a repressor of abscisic acid (ABA) synthesis (Zhang et al., Develop. Cell 2020, 55, 529-543).

Different environmental factors, such as temperature, wind, soil salinity, water availability (excess or deficiency) and nutrients, ultraviolet radiation, chemical contamination, among others, cause different types of stress in plants, such as oxidative stress, osmotic stress and ionic stress (toxicity). Among the different stressors, saline is one of the most acute in causing all three types of stress (Munns, Plant, Cell and Environ., 2002, 25, 239-250; Yang and Guo, New Phytologist, 2018, 217, 523-539).

Oxidative stress reflects an imbalance between reactive oxygen species (ROS) and the ability of a biological system to readily detoxify reactive intermediates or repair the resulting damage. (Malik, et al (editors), Plant Biotechnology: Principles and Applications, 2017). However, it is important to consider that ROS are necessary at basal levels for proper plant physiological activity, acting as messenger molecules in multiple processes such as cell proliferation, stress acclimation, signal translation, differentiation and development, metabolic regulation, defense against pathogens, and physiological cell death. The problem arises when its production exceeds the plant's detoxification capacity, so the accumulation of ROS causes cytotoxicity, damaging vital components such as DNA and RNA, the lipid layer of the cell membrane by causing its peroxidation, as well as the oxidation of different proteins, amino acids and photosynthetic pigments (Mittler, Trends in Plant Sci., 2017, 22, 1; Hasanuzzaman et al., Cells, 2021, 10, 2537). To regulate ROS concentrations, plants have a battery of control mechanisms classified as enzymatic and non-enzymatic responses. As part of the enzymatic response, there are a number of enzymes, such as superoxide dismutase (SOD), catalase (CAT), ascorbate peroxidase (APX), monodehydroascorbate reductase (MDHAR), dehydroascorbate reductase (DHAR), glutathione reductase (GR) and guaiacol peroxidase (GP), which catalyze different reactions to deactivate reactive oxygen species. On the other hand, the non-enzymatic response includes a series of molecules, such as ascorbic acid, reduced glutathione, a-tocopherol, carotenoids, flavonoids and proline that act as cosubstrates of some of the enzymes previously mentioned, or as scavengers of some of the reactive species, such as singlet oxygen, hydroxyl radical and/or hydrogen peroxide, protecting the cell membrane from lipid peroxidation or other components of oxidation and damage (Das and Roychoudhury, Front. Environ. Sci., 2014, 2, 53).

Osmotic stress, on the other hand, is related to the flow of water through a semipermeable membrane, such as the cell membrane. When the concentration of water-soluble compounds outside the cell is greater than inside, a condition called hypertonic is created, which causes water to escape into the hypertonic medium (osmosis) and therefore dehydrate the cell and, consequently, reduce its size. This phenomenon, known as plasmolysis, can cause an irreversible separation of the plasma membrane from the plant cell wall, preventing the cell from returning to its normal state. If dehydration is not severe, there may be incipient plasmolysis, in which case the cell may return to its natural state. To reduce the effects of osmotic stress, plants have developed an increased synthesis of a series of osmolytes that seek to balance the concentration of soluble molecules outside the cell, thereby preventing the flow of water through osmosis. The osmolytes produced by the cell are of different chemical nature, such as sugars (sorbitol, mannitol, sucrose, glucose, fructose, galactose, mannose, etc.), amino acids (proline), quaternary amines (glycine betaine) and polyamines (putrescine, spermine, spermidine) (Zhu, Cell, 2016, 167, 313-234).

Ionic stress is mainly related to the accumulation of sodium cation, which causes an imbalance in the homeostasis of other important ions, such as K⁺ and Ca², in addition to hindering proper glycation of RuBisCo, decreasing its catalytic efficiency in CO₂ fixation and therefore of photosynthesis; therefore, sodium is considered to be toxic. To avoid the toxicity caused by sodium accumulation, plants have developed a series of responses, one of which is regulated by the SOS system, which activates proton pumps (ATPases) and sodium transporters that expel sodium from the cell or encapsulate it in the vacuole. This same system, complemented by other genes, such as AKT1, promotes the entry of potassium and prevents its exit in an attempt to restore homeostasis (Assaha et al., Front. Physiol., 2017, 8, 509).

The ability of plants to resist or tolerate abiotic stress is considered to be related to the efficiency, at the first level, of their signal sensors, perception and transduction, among which are osmosensors (e.g. AtHK1), phospholipases (e.g. PLD), secondary messengers (e.g. Ca²⁺, PtdOH, ROS), MAP kinases, Ca²⁺ sensors (e.g. SOS3), calcium-dependent protein kinases (e.g. CPDKs). At the second level is the efficiency of transcriptional control, in which different factors participate (e.g. CBF/DREB, ABF, HBF, HSF, bZIP, MYC/MIB). Finally, the third level is in the stress response mechanisms with the activation of different genes that promote detoxification (e.g. SOD, PX), osmoprotection (proline, glycine betaine, polyol sugars), chaperone functions (e.g. Hsp, SP1, LEA, COR) and the movement of water and ions (e.g. aquaporins, ion transporters). These mechanisms seek to restore cellular homeostasis and the structural and functional protection of proteins and membranes (Wang et al., Planta, 2003, 218, 1-14). In this context, various products, such as phytohormones and/or biochemical or microbial biostimulants, which particularly improve the third level of response, may enhance plant tolerance or resistance to abiotic stress. For example, Esan et al (EJFOOD, 2020, 2(6), 1-4) reported the direct correlation between the exogenous application of IAA and the increase of photosynthetic pigments, such as chlorophylls and carotenoids. One of the first systems to be damaged or stopped by abiotic stress, particularly salinity stress, is the photosynthesis system. This is why increasing the content of photosynthetic pigments and improving or maintaining the photosynthesis system has a double effect in stressful situations: 1) Pigments, particularly carotenoids, act by deactivating reactive oxygen species (ROS); therefore, they are elements that mitigate oxidative stress; 2) an intact or improved photosynthetic system maintains or increases the production of sugars, polyols, and polyamines derived from central metabolism; molecules that are considered osmolytes, understood as elements that reduce osmotic stress.

A group of molecules of botanical origin, classified as phenolic compounds, are possibly the most abundant secondary metabolites in plants and are often found in the cell walls and vacuoles of epidermal and subepidermal cells (Lattanzio et al (editors), Phytochemistry: Advances in Research, 2006, 661, 23-67). These phenolic compounds can be constitutive or inducible. Constitutive phenolic compounds are synthesized during normal growth and development, while inducible phenolic compounds are synthesized in response to biotic and abiotic stresses. The functions of endogenous phenolic compounds in plants are very diverse. They act as antioxidants, scavenging reactive oxygen species; they accumulate in the epidermis to act as screens against harmful UV radiation; they defend plants against herbivores, pathogens, and weeds; they enhance nutrient mobilization and absorption; they are involved in seed germination and dormancy; phenols, especially anthocyanins, act as pigments that attract pollinators and seed dispersal agents, etc. (Jain et al., Int. J. Pharm. Sci. Res., 2019, 10, 494-504; Takshak and Agrawal, J. Photochem. Photobiol. B Biol., 2019, 193, 51-88; Bhattacharya et al., Mol. Plant Pathol., 2010, 11, 705-719; Sharma et al., Molecules 2019, 24, 2452). One of the recent reviews clearly shows the response and role of endogenous phenols in plant tolerance to abiotic stress factors such as heavy metals, drought, salinity, ultraviolet light and heat among others (Sharma et al., Molecules 2019, 24, 2452). It has been suggested that these effects are achieved because phenolic compounds regulate the activity of phytohormones, modulate the activity of certain enzymes and increase the synthesis of some important metabolites, thereby influencing metabolism, photosynthesis, nutrient absorption and other physiological processes in plants to stimulate their growth and development (Yakhin et al., Front. Plant Sci. 2017, 7, 2049). Phytohormones such as auxins, cytokinins, and gibberellins are known to promote growth, while others, such as abscisic acid, inhibit it; it has been found that phenolic compounds and extracts increase the levels of the former and decrease the levels of the latter (Abdalla, Int. J. Plant Physiol. Biochem., 2013, 5, 42-49). However, although several studies show the influence of phenolic compounds and extracts on the activity of phytohormones, a deep understanding of their modes of action and the underlying mechanisms at the molecular level is generally lacking. Likewise, phenolic compounds and extracts modulate the activity of antioxidant enzymes, such as catalase, peroxidase, and superoxide dismutase, by stimulating the production of antioxidant compounds such as ascorbic acid and flavonoids, which inactivate reactive oxygen species whose accumulation during periods of stress can cause damage to cellular structures. In Abdalla's study (Int. J. Plant Physiol. Biochem., 2013, 5, 42-49), Moringa oleifera extract decreased the activity of peroxidase, superoxidase dismutase and catalase enzymes, as well as lipid peroxidation, while increasing the levels of endogenous phenolic compounds and ascorbic acid in treated plants. In addition to promoting the synthesis of these types of compounds, it has been shown that phenolic extracts and compounds can also promote the formation of chlorophyll, carotenoids, proteins, sugars, and amino acids, among many others. While endogenous phenols and ascorbic acid allow plants to counteract the accumulation of reactive oxygen species, an increase in chlorophyll and carotenoids helps plants to improve their photosynthetic rates and transpiration (stomatal conductance) (Abdalla, Int. J. Plant Physiol. Biochem., 2013, 5, 42-49).

Although the exogenous application of different extracts and phenolic compounds has shown that it can improve different agronomic variables (germination, emergence, growth, vigor, yield, quality, etc.) of different crops (Kisiriko et al., Molecules, 2021, 26(21), 6343), to date there is no report that refers to a phenolic extract or compound having a strong and effective effect against abiotic stress, particularly against saline stress. Nor is there any about a phenolic extract or compound, combined with other molecules, such as glycine betaine, having a synergistic, powerful and effective effect against abiotic stress, particularly against saline stress.

Numerous studies have established the important roles of glycine betaine (GB) in plant response to abiotic stresses, including salinity, drought, and low temperature (Munns and Tester, Annu. Rev. Plant. Biol., 2008, 59, 651-81; Annunziata et al., Front. Plant Sci., 2019, 10, 230; Bai et al., Biotechnol. Lett., 2022, 44, 367-386). Certain glycophyte plants can synthesize and accumulate GB to adapt to saline stress (Annunziata et al., Front. Plant Sci., 2019, 10, 230). However, the biosynthesis of this compound in plant tissues is energy intensive (Makela et al., Plant Science, 1996, 121, 221-230). Therefore, exogenous application of GB may be crucial to improve plant tolerance to abiotic stresses, including salinity. Exogenous application of GB improves plant stress tolerance by activating the ROS scavenging system, which reduces peroxidation of membrane systems, helping to maintain membrane stability under saline conditions (Banu et al., Biosci. Biotechnol. Biochem., 2010, 74, 2043-2049; Gupta and Huang, Int. J. Genom., 2014, 18). Similarly, GB, being an osmolyte, reduces osmotic water loss (Ashraf and Foolad, Environ. Exp. Bot., 2007, 59, 206-216; Bai et al., Biotechnol. Lett., 2022, 44, 367-386). Furthermore, GB preserves the thermodynamic stability of proteins, which prevents their aggregation and helps maintain their normal functional activities. Studies conducted over the past 25 years have shown that GB protects the normal structure and activity of the photosynthetic reaction center (PSII) and enhances RuBisCo activity under drought stress (Papageorgiou and Murata, Photosynth. Res., 1995, 44(3), 243-52; Huang et al., Plant Physiol., 2000, 122, 747-756). GB has also shown that it is capable of promoting the overexpression of genes, such as ATPase and sodium transporters (ZmMHA2, ZmMHA4, ZmYP1 and ZmNHX1), involved in the SOS response to saline stress, causing the expulsion of the sodium cation from the cell or its encapsulation in the vacuole, although this overexpression occurs only under saline stress conditions (Zhu et al., Front. Plant Sci., 2022, 13, 978304.) However, to date there is no report that GB presents a synergistic effect against abiotic stress, particularly against saline stress, when applied jointly with an extract or phenolic compound.

A composition containing polyphenols (PP), obtained from the acid hydrolysis of agricultural husks, particularly rice husks, was found to improve plant growth under both normal and abiotic stress conditions, particularly saline stress. In the prior art related to the invention, as described in U.S. Pat. No. 5,352,264, polyphenols (PP) are obtained from agricultural husks according to the process described in the patent, with some modifications. Basically, this invention describes “the extraction of polyhydroxycarboxylic acids, carbohydrates and alcohols from plant waste, mainly rice and oat husks.” As described in U.S. Pat. No. 5,352,264, polyhydroxycarboxylic acids come from the partial oxidation of pentoses obtained during the hydrolysis of hemicellulose contained in agricultural husks. However, processes with diluted acids, such as the one described in U.S. Pat. No. 5,352,264, also promote the removal of lignin, as described in different scientific articles (Bhutto et al., Energy, 2017, 122, 724-745; Kim, et al., Carbohydrate Polymers, 2014, 99, 563-567). Specifically, the improvements or modifications to the method include the introduction of adsorption/desorption processes for the effective recovery of polyphenols (PP) derived from lignin and found in the acidic solution from the hydrolysis of agricultural husks. The selection of adsorbent materials with a high specific adsorption capacity but which also facilitate the release of adsorbates during the desorption stage, the selection of the desorption or elution solvent, as well as the establishment of the process parameters, are not obvious to a person skilled in the art since the particular characteristics of the adsorbates and the rest of the components of the solution must be considered in order to achieve high selectivity in the adsorption operation and facilitate the desorption or elution operation.

As regards to others, the differences and the object of the invention, it can be pointed out that in a second aspect, the present invention is directed to providing methods for improving plant growth and comprising the application of effective amounts of PP recovered from an acid extract of agricultural husks, particularly rice husk; in a third aspect, the present invention is directed to providing a method for improving plant tolerance to abiotic stress, particularly saline stress, comprising the application of an effective amount of PP recovered from an active acid extract of agricultural husks, particularly rice husk, and finally, in a fourth aspect, the present invention is directed to providing a method for improving plant tolerance to abiotic stress, particularly saline stress, comprising the application of an effective amount of PP recovered from an active acid extract of agricultural husks, particularly rice husk, and glycine betaine, both acting synergistically and applied in a ratio (w/w) of 1:1 to 1:3; where the polyphenol (PP) content is expressed as gallic acid equivalents in 100 g of sample, according to the Folin Ciocalteu method.

### BRIEF DESCRIPTION OF THE FIGURES

The characteristic details of the invention are described in the following paragraphs together with the accompanying figures, which are for the purpose of defining the invention, but without limiting its scope.

FIG. 1 is an expression level of the genes evaluated in the roots of tomato seedlings (Solanum lycopersicum). The graphs represent the average expression level (2-ΔΔCt fold change) of the genes evaluated at different times after the application of PP extracted from rice husk (white bars) versus control plants (no treatment, black bars). The lines in the bars represent the standard error of two biological replicates and two technical replicates.

### DETAILED DESCRIPTION OF THE INVENTION

The present invention relates to improvements to a method for extracting an active acid extract from agricultural husks, particularly rice husks, where the active acid extract is obtained through the following phases:

### a) Pentose Extraction Phase:

Sift agricultural husks, preferably rice or oat, individually or in combination, until obtaining a particle size between 24 and 90 mesh, to subsequently promote acid hydrolysis by adding an acid solution, preferably nitric acid and preferably at a concentration of 1 to 25% (w/v), in a liquid/solid ratio of 3:1 to 5:1. Subsequently, steam is injected, preferably at a pressure of 7.0 to 9.0 kg/cm² and the liquid-solid mixture is stirred until a temperature between 75 to 85° C. is obtained. Once the temperature is reached, an additional quantity of acid is added, preferably nitric acid, until a concentration preferably of 1.7 to 41% (w/v) is reached, maintaining the same temperature until the end of the hydrolysis, which in total lasts from 8 to 20 hours, with stirring provided intermittently by the injection of steam through diffusers to maintain the temperature, to finally obtain a hydrolyzed solution containing pentoses.

### b) Oxidation Phase:

Add an additional amount of acid, preferably nitric acid, to reach a concentration preferably of 2.2 to 47% (w/v), to the hydrolyzed solution containing the pentoses, and maintain the temperature in a range of 70 to 85° C., for 4 to 10 hours, by injecting steam, preferably at a pressure of 7.0 to 9.0 kg/cm². Subsequently, allow it to cool to room temperature to obtain a mixture of acids comprising the group of monocarboxylic and dicarboxylic acids, such as oxalic acid and 2,3,4 trihydroxy pentanedioic acid, and other non-oxidized or partially oxidized molecules, such as alcohols and aldehydes and other compounds such as carbon dioxide. The resulting acid mixture is allowed to settle to facilitate phase separation by decantation, and finally, the supernatant free of large particles, such as agricultural husk residue, is recovered.

### c) Clarification and Concentration Phase:

Filter the supernatant free of large particles to obtain a primary filtrate. The primary filtrate is then concentrated by vacuum evaporation at an absolute pressure of 145 to 200 mm Hg and a maximum boiling point of 45 to 60° C. to obtain a clarified and concentrated product of 1.5:1 to 3.5:1.

### d) Adsorption or Retention Phase:

Circulate the filtered or clarified and concentrated product through columns packed with 1 to 4 kg, preferably 1.5 to 3 kg of granular activated carbon or a quantity of high specific adsorption capacity resin that can be packed in a volume equivalent to the effective volume of the columns given by an internal diameter of 10.16 cm and an effective height of 85 cm. The selected resins with a high specific adsorption capacity are included in the group of macroporous polystyrene resins functionalized with tertiary amines, such as Purolite® MN-102, or with other hydrophilic molecules, or resins from the amberlite family.

Apply an optimal influent flow rate between 1.0 to 6.0, preferably between 1.5 to 4.5 PBV h-1 (packed bed volumes per hour) for the development and inclusion of an adsorption process so that phenolic compounds and flavonoids contained in low concentrations in the clarified and concentrated product and circulated as influent in the columns, are adsorbed and retained in the adsorbent material; while other secondary compounds, such as aliphatic polyhydroxycarboxylic acids, carbohydrates, alcohols and aldehydes, are eliminated in the effluent.

### e) Purification Phase:

Wash in counterflow with 5 to 50 L, preferably with 15 to 30 L of acidified water (pH<4), the columns containing the phenolic compounds and flavonoids adsorbed on the activated carbon or resins with high specific adsorption capacity, to eliminate other residual compounds, such as aliphatic polyhydroxycarboxylic acids, carbohydrates, alcohols and aldehydes, absorbed between the pores of the activated carbon or macroporous resins that could act as contaminants during the desorption or elution process. Additionally, to facilitate the subsequent desorption or elution process, the columns are drained of the wash water and dried by circulating air in counterflow for 5 to 30 minutes, preferably for 10 to 20 minutes.

### f) Desorption Phase:

Circulate in counterflow 10 to 40 L, preferably 15 to 25 L of 96% (v/v) ethanol or an alkaline aqueous solution of 0.05 to 0.2 M potassium hydroxide, preferably 0.1 to 0.2 M, through the columns packed with the adsorbed polyphenolic compounds, maintaining the pH in a range of 7.0 to 10, preferably between 7.5 to 9.0, to favor the solubility of the adsorbed compounds and facilitate the desorption or elution process to obtain a concentrated active acid extract with polyphenols in a concentration range between 3 to 10 g equivalent of gallic acid/100 mL.

In one of the preferred embodiments of the present invention, the resulting active acid extract with polyphenols in concentrations between 3 to 10 g equivalent of gallic acid/100 mL is formulated together with glycine betaine until reaching a final concentration between 0.5 to 2.5% g equivalent of gallic acid/100 g of sample, preferably between 1.0 to 2.0%, while GB is in a concentration between 1 to 5%, preferably between a concentration between 2 to 3%, maintaining a polyphenols (PP)/glycine betaine (GB) ratio between 1:1 to 1:3. For the application of the formulation for plant treatment, said formulation must be diluted in water until reaching final concentrations of effective field doses of 0.0014 to 0.0105% (w/v) of polyphenols (PP) and 0.0030 to 0.0225% of glycine betaine (GB), applying between 400 to 1000 L/Ha of the diluted solution. The “effective amount or dose” may vary, depending on the concentration of the PP and GB in the formulations, the variety of plant or plant species to be treated, the severity of the stress, the desired result and/or the phenological development stage of the plants, among the most relevant factors, therefore, it is not always possible to specify exactly an “effective amount”, although in each particular case, this can be established by a common expert in the art.

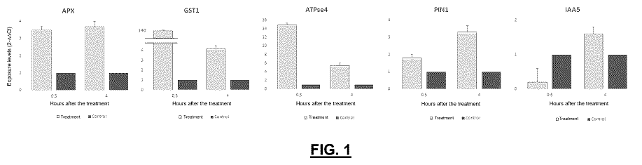

The active acid extract alone or in formulation with GB, is used to promote plant growth and development under normal conditions or under abiotic stress, particularly under salinity stress, and which comprise the application of effective doses in solution to monocotyledonous plants, such as a cereal or grass, preferably corn or to an amaryllidaceae, preferably onion; and dicotyledons of the Solanaceae family, preferably tomato, chili, pepper and potato or of the Rosaceae family, preferably apple, or of the Malvaceae family, preferably cotton, or of the Cucurbitaceae family, preferably watermelon, melon or cucumber, or of the Asparagaceae family, preferably asparagus (Table 1 and Table 2). The active acid extract individually or in formulation with GB, promotes the overexpression of genes involved in the response to oxidative stress, such as APX, ascorbate peroxidase; GST1, glutathione S-transferase-1; ion transport, such as ATPse4, ATPase4; auxin transport, such as PIN1, PINFORMED; and response to auxins, such as IAA5, Inducible Indole-3-acetic Acid 5; under normal conditions or under abiotic stress, particularly under salinity stress in monocotyledonous plants, such as a cereal or grass, preferably corn or an amaryllidaceae, preferably onion; and dicotyledons of the Solanaceae family, preferably tomato, chili, pepper and potato or of the Rosaceae family, preferably apple, or of the Malvaceae family, preferably cotton, or of the Cucurbitaceae family, preferably watermelon, melon or cucumber, or of the Asparagaceae family, preferably asparagus (FIG. 1). In the case of cereals, such as corn, the formulation with the active acid extract is applied during the vegetative stage of growth, starting in V2 and ending in VT, at a concentration of 1 to 3 L/Ha, divided into 2 to 3 applications. In the case of apple cultivation, 1 to 5 L per hectare is applied, preferably 2 to 4 L per hectare, divided into 3 applications, starting after the sprouting period and at intervals of 20 to 30 days. For vegetable crops such as asparagus, chili, tomato and onion, the same concentration is applied in 3 applications, starting after the sprouting period and at intervals of 15 to 20 days, while for cotton crops, in a single application, of the same concentration after the sprouting period.

Optionally, the formulation with the active acid extract is applied with a herbicide, such as glyphosate, halosulfuron, or others; a fungicide, such as strobirulins, tetraconazole, or others; a nematicide, such as strobirulins, tetraconazole, or others; and nitrogen fertilizers, such as ammonium nitrate, potassium nitrate, urea, or micronutrients.

Optionally, the formulation with the active acid extract is applied directly to the soil by any convenient means, including sprinkling, drip irrigation systems, tape irrigation systems, or others that are obvious to anyone skilled in the art. The following examples are intended to illustrate the present invention and to teach one skilled in the art how to use the formulations and methods of the present invention, but are not limiting in any way.

### Example 1. Effect at the Genetic Level, in Tomato Seedlings, of the Application of the Formulation with the Active Acid Extract Containing Polyphenols (PP)

In one of the preferred embodiments, the application of the formulation with the active acid extract to tomato seedlings promotes changes in the expression of key genes in metabolic pathways related to growth and tolerance to abiotic stress, as illustrated in FIG. 1.

The experiment was established under a randomized complete block design with three replications. The experimental unit consisted of 20 plants for each treatment, giving a total of 120 plants for the entire study.

To evaluate the effect of PP on gene expression in tomato seedlings (30 days after germination), two treatments were applied, as follows: 1) Absolute witness (water), 2) PP in aqueous solution (0.0028% gallic acid equivalents). Three applications of one liter per plant were made with an interval of 7 days between each one, the first application being at the time of transplant. After the third application of the treatments, root sampling was carried out at 0.5 h and 4 h after application. Finally, expression levels were determined using the 2-ΔΔCt method (Nolan et al., Nat. Protoc., 2006, 1(3), 1559-82) comparing the expression levels of treated plants versus control plants.

An overexpression of up to 100% of the IAA5 gene and up to 200% of the PIN1 gene was observed, the first related to the endogenous production of auxins, such as indole acetic acid (IAA) and the second involved in the polar transport of this. In addition to promoting improved root development, an increase in chlorophyll and carotenoid content was observed, consistent with the well-known correlation between exogenous application of IAA and increased photosynthetic pigments, such as chlorophyll and carotenoids. Overexpression of up to 400% of the GST1 gene and up to 350% of the APX gene, both involved in the response to oxidative stress, was also observed. Another of the most relevant discoveries of the present invention is that PP promotes an overexpression of up to 1500% of genes from the ATPase family, key elements of the SOS response of plants to ionic stress caused by sodium.

### Example 2. Application of the Formulation with the Active Acid Extract Containing Polyphenols (Pp) and Glycine Betaine (Gb) and its Effect at the Physiological and Development Level of Tomato Plants, Grown in a Greenhouse, Under Normal Conditions or in Saline Soils

TABLE 1
Effect of the treatments evaluated on tomato plants under three soil salinity conditions.

| | Non-saline soil (NS) | | | Saline (S) | | | Very saline (VS) | | |
|---|---|---|---|---|---|---|---|---|---|
| Variables | | D2 | D4 | | D2 | D4 | | D2 | D4 |
| evaluated | Control | (0.4 mL/L) | (0.8 mL/L) | Control | (0.4 mL/L) | (0.8 mL/L) | Control | (0.4 mL/L) | (0.8 mL/L) |
| Fresh root | 1.2 | 1.4 | 1.8* | 1 | 2.5* | 2.3* | 1.5 | 2.8* | 3.0* |
| weight (g) | | | | | | | | | |
| Fresh weight | 9 | 9 | 9.1 | 9 | 11* | 10* | 11 | 11 | 13* |
| of stem (g) | | | | | | | | | |
| Fresh leaf | 16 | 18* | 18* | 17 | 23* | 22* | 20 | 25* | 26* |
| weight (g) | | | | | | | | | |
| Chlorophyll | 10 | 11* | 11* | 11 | 12* | 12* | 8 | 13* | 11* |
| II a (mg g⁻¹) | | | | | | | | | |
| Chlorophyll | 2 | 2 | 2 | 6 | 4 | 4 | 3 | 4 | 5* |
| II b (mg g⁻¹) | | | | | | | | | |
| Carotenoids | 2.5 | 2.7* | 2.7* | 2.1 | 2.9* | 2.7* | 2.0 | 3.0* | 2.7* |
| (mg g⁻¹) | | | | | | | | | |
| Na⁺ in | 550 | 400* | 320* | 800 | 580* | 590* | 900* | 700* | 690* |
| root (μmol g⁻¹) | | | | | | | | | |
| Cl⁻ in | 700 | 610* | 600* | 1020 | 980* | 970* | 1300 | 1180* | 1160* |
| root (μmol g⁻¹) | | | | | | | | | |
| K⁺ in root | 300 | 280* | 310 | 370 | 380 | 390* | 400 | 410 | 400 |
| (μmol g⁻¹) | | | | | | | | | |
| Ca²⁺ in | 56 | 58 | 57 | 34 | 36 | 37 | 35 | 65 | 55* |
| root (μmol g⁻¹) | | | | | | | | | |
| Na⁺ in | 480 | 400* | 350* | 700 | 520* | 450* | 850 | 650* | 570* |
| leaf (μmol g⁻¹) | | | | | | | | | |
| Cl⁻ in | 780 | 780 | 620* | 1180 | 1000* | 1080* | 1620 | 1200* | 1380* |
| leaf (μmol g⁻¹) | | | | | | | | | |
| K⁺ in | 480 | 700* | 690* | 980 | 800* | 1200* | 800 | 680* | 860 |
| leaf (μmol g⁻¹) | | | | | | | | | |
| Ca⁺² in | 110 | 180* | 150* | 100 | 105 | 95 | 220 | 230 | 235* |
| leaf (μmol g⁻¹) | | | | | | | | | |
| Pro (μmol | 22 | 20 | 18 | 116 | 96* | 90* | 132 | 110* | 108* |
| g⁻¹ (DW) | | | | | | | | | |
| TSS (mg eq | 185 | 215* | 225* | 170 | 190* | 210* | 165 | 185* | 200* |
| glucose g⁻¹) | | | | | | | | | |
| GB (μmol | 5.5 | 8.0* | 12* | 7.2 | 9.0* | 14* | 9.0 | 13* | 14* |
| g⁻¹ DW) | | | | | | | | | |
| MDA (nmol | 335 | 250* | 235* | 450 | 200* | 225* | 525 | 325* | 350* |
| g⁻¹ (DW) | | | | | | | | | |
| H₂O₂ (nmol | 11.2 | 9.0* | 8.7* | 17.5 | 6.2* | 10.2* | 20 | 13* | 11.7* |
| g⁻¹ DW) | | | | | | | | | |
| TPC (mg eq | 12.5 | 11 | 14 | 12.5 | 7* | 10* | 12.2 | 12 | 12.5 |
| GA g⁻¹ DW) | | | | | | | | | |
| TF (mg eq | 6.6 | 4.9 | 7 | 6.9 | 4.1 | 4.7* | 4.5 | 4 | 5.3* |
| C g⁻¹ DW) | | | | | | | | | |
| SOD (U · | 210 | 150* | 125* | 487.5 | 400* | 300* | 675 | 500* | 450* |
| mg⁻¹ protein) | | | | | | | | | |
| CAT (U · | 74 | 54* | 45* | 90 | 75* | 62* | 120 | 100* | 82* |
| mg⁻¹ protein) | | | | | | | | | |
| GR (U · | 535 | 350* | 335* | 1050 | 650* | 550* | 1550 | 900* | 735* |
| mg⁻¹ protein) | | | | | | | | | |

The experiments were carried out at the facilities of the Polytechnic University of Valencia (Valencia, Spain). The experiment was established under a multivariate design consisting of three salinity conditions (non-saline (NS), saline(S) and very saline (VS) soils), using two doses of a formulation containing between 1 to 2% (gallic acid equivalents/100 ml of sample) of PP and 2 to 4% of GB (w/v), (D1=0.4 mL/L and D2=0.8 mL/L), and two evaluation periods (30 and 60 days after transplant). Control plants (DO, without the formulation) were grown in parallel, maintaining the same experimental design. Each experimental unit consisted of 6 plants for each treatment, with four applications of one liter per plant with an interval of 15 days between each one, the first application being at the time of transplant. After the fourth application of the treatments, the roots and aerial parts were collected separately for their respective quantification.

The results of the variables evaluated are summarized in the following table, showing significant differences between the control and the treatments (*), mainly at 60 days after transplantation.

*Indicates significant difference (p<0.05) in relation to the control group

The fresh weight analysis in the treated plants showed a favorable response on their development, mainly under high salinity conditions (S and VS), in which the values of the means (root, stem and leaves) were considerably higher than in the control plants. On the other hand, the application of the treatments significantly increased the average levels of photosynthetic pigments (chlorophylls and carotenoids) after the second application.

Of particular note is the fact that lower levels of Nat were found in treated plants, both in roots and leaves, at 30 and 60 days, compared to tomato plants grown in the absence of treatments.

The higher content of sugars (TSS) and other osmolytes, such as glycine betaine (GB) in the treated plants is also notable, particularly under salinity conditions (S and VS).

As a consequence of a greater accumulation of pigments, particularly carotenoids, the greater accumulation of sugars and GB, and relevantly, the lower accumulation in tissues (root and leaves) of Nat, there is a clear mitigation of oxidative, osmotic and saline stress respectively, demonstrated through lower values of practically all the different stress indicators (PRO, MDA, H₂O₂, SOD, CAT and GR) in treated plants, compared to the corresponding controls.

### Example 3. Application of the Formulation with the Active Acid Extract Containing Polyphenols (Pp) and Glycine Betaine (Gb) and its Effect at the Physiological and Development Level of Tomato Plants, Grown in a Greenhouse, Under Normal Conditions or Under Irrigation with Brackish Water

The experiments were carried out in the greenhouses of the facilities of the Polytechnic University of Valencia (Valencia, Spain). The experiment was established under a multivariate design consisting of four conditions, two of salinity (non-saline soils (NS) and saline soils (SS)) and two irrigation waters (non-saline (WN) and saline (WS)), using two doses of a formulation containing between 1 to 2% (equivalents of gallic acid/100 ml of sample) of PP and 2 to 4% of GB (w/V), (D1=0.4 mL/L and D2=0.8 mL/L), and two evaluation periods (30 and 60 days after transplant). Control plants (DO, no treatment) were grown in parallel, maintaining the same experimental design. The experimental unit consisted of 120 plants in total for the test. Four applications of one liter per plant were made with an interval of 15 days between each one, the first application being at the time of transplant. After the fourth application of the treatments, the roots and aerial parts were collected separately.

The results of the variables evaluated 60 days after transplantation are summarized in the following table, showing significant differences between the control and the treatments (*).

TABLE 2
Effect of the evaluated treatments on tomato plants subjected to increasing salinity
due to different combinations of saline or non-saline soil and irrigation water.

| | Non-saline soil | | Saline soil | | Non-saline soil | | Saline | |
|---|---|---|---|---|---|---|---|---|
| | and non-saline | | and non-saline | | and saline | | soil and | |
| Variables | water (NSWN) | | water (SSWN) | | water (NSWS) | | water (SSWS) | |
| evaluated | Control | Treated | Control | Treated | Control | Treated | Control | Treated |
| Fresh root | 8.6 | 11.2* | 7.5 | 10.2* | 2.1 | 3.6* | 1.1 | 1.7* |
| weight (g) | | | | | | | | |
| Fresh weight | 27.5 | 31.2* | 20 | 25* | 12.5 | 15* | 5 | 7.5* |
| of stem (g) | | | | | | | | |
| Fresh leaf | 55 | 60* | 45 | 53* | 28 | 38* | 15 | 25* |
| weight (g) | | | | | | | | |
| Chlorophyll | 10.7 | 16.3* | 10 | 13.8* | 5.4 | 10.4* | 1.8 | 4.8* |
| II a (mg g⁻¹) | | | | | | | | |
| Chlorophyll | 2.8 | 4.4* | 2.5 | 4.5* | 1.2 | 2.8* | 0.62 | 1.65* |
| II b (mg g⁻¹) | | | | | | | | |
| Carotenoids | 1.9 | 2.5 | 1.1 | 2 | 1.1 | 1.8 | 0.40 | 0.8* |
| (mg g⁻¹) | | | | | | | | |
| Na⁺ in | 400 | 100* | 550 | 400* | 1350 | 1050* | 1520 | 1280* |
| root (μmol g⁻¹) | | | | | | | | |
| Cl⁻ in | 180 | 100* | 880 | 700* | 1280 | 950* | 1520 | 1280* |
| root (μmol g⁻¹) | | | | | | | | |
| K⁺ in | 210 | 290* | 190 | 240* | 100 | 180* | 60 | 150* |
| root (μmol g⁻¹) | | | | | | | | |
| Ca²⁺ in | 80 | 95* | 70 | 80* | 12.5 | 25* | 10 | 12.5* |
| root (μmol g⁻¹) | | | | | | | | |
| Na⁺ in | 100 | 50* | 250 | 100* | 2320 | 1700* | 3200 | 2750* |
| leaf (μmol g⁻¹) | | | | | | | | |
| Cl⁻ in | 450 | 320* | 1200 | 950* | 3750 | 2870* | 4950 | 3950* |
| leaf (μmol g⁻¹) | | | | | | | | |
| K⁺ in | 790 | 880* | 630 | 760* | 480 | 650* | 360 | 570* |
| leaf (μmol g⁻¹) | | | | | | | | |
| Ca²⁺ in | 300 | 400* | 280 | 380* | 115 | 120 | 50 | 120* |
| leaf (μmol g⁻¹) | | | | | | | | |
| Pro (μmol | 30 | 15* | 225 | 200 | 690 | 550* | 1140 | 840* |
| g⁻¹ (DW) | | | | | | | | |
| TSS (mg eq | 275 | 380* | 205 | 305* | 110 | 255* | 60 | 145* |
| glucose g⁻¹) | | | | | | | | |
| GB (μmol | 5 | 10* | 8 | 11 | 10 | 15* | 11 | 19* |
| g⁻¹ DW) | | | | | | | | |
| MDA (nmol | 200 | 100* | 400 | 200* | 1000 | 600* | 1500 | 1100* |
| g⁻¹ (DW) | | | | | | | | |
| H₂O₂ (nmol | 8 | 5* | 12 | 9* | 31 | 20 | 47 | 31 |
| g⁻¹ DW) | | | | | | | | |
| TPC (mg eq | 10 | 9 | 10.5 | 9 | 12.5 | 11 | 13 | 11 |
| GA g⁻¹ DW) | | | | | | | | |
| TF (mg eq | 4 | 3.7 | 4.7 | 4 | 5.3 | 4.5 | 7.5 | 5.2* |
| C g⁻¹ DW) | | | | | | | | |
| SOD (U · | 400 | 300* | 700 | 400* | 1000 | 700* | 1400 | 1100* |
| mg⁻¹ protein) | | | | | | | | |
| CAT (U · | 75 | 50* | 100 | 62* | 175 | 125* | 240 | 165* |
| mg⁻¹ protein) | | | | | | | | |
| GR (U · | 500 | 250* | 1000 | 625* | 1500 | 1000* | 2750 | 1500* |
| mg⁻¹ protein) | | | | | | | | |

A first aspect to highlight is the fact that the formulation stimulates plant development under normal conditions, according to the values of the variables of fresh root weight, fresh stem weight and fresh leaf weight respectively. As salinity conditions increased to the most extreme condition of saline soil and brackish water irrigation (SSWN<NSWS<SSWS), plant development decreased significantly, although in treated plants, this decrease was markedly less drastic than in the control groups. For example, under the highest salinity condition (SSWS), the fresh weights of root, stem and leaf of the treated group were 55, 50 and 67% higher than those of the control group, respectively. Similarly, this effect was reflected in a less marked reduction compared to the control of other growth parameters, such as plant height, stem diameter and number of leaves (data not shown).

A second aspect to highlight is the effect of the formulation on the increase of photosynthetic pigments, such as chlorophylls and carotenoids, under normal growing conditions. As salinity conditions increased, reaching the most extreme conditions of saline soil and brackish water irrigation (SSWS), the production of these pigments declined sharply, affecting the photosynthetic process, which explains the drastic decline in plant development. However, although the production of these pigments was also affected in treated plants grown under saline conditions, their decrease was markedly less drastic than in the corresponding control groups. For example, under the highest salinity condition (SSWS), the chlorophyll a, chlorophyll b and carotenoid contents of the treated group were 167, 166 and 100% higher than those of the control group, respectively.

A third aspect to highlight is the effect of the formulation on the sodium ion content (Nat). This content increased significantly in the roots and leaves of tomato plants in the control groups in proportion to the increase in salinity (SSWN<NSWS<SSWS). Although in the treated plants there was also an increase in the content of the Nation, this increase was between 15 and 25% below the increases observed in the control groups, under the various conditions evaluated. Also relevant, under different salinity conditions, the contents of the K⁺ and Ca²⁺ cations, both at the leaf and root level, increased by 45 to 140% in treated plants compared to the control groups. This aspect clearly demonstrates an improvement in cellular homeostasis provided by the SOS response mechanism of plants to salinity stress.

A fourth aspect to highlight is the increase in the content of osmolytes, such as total soluble sugars (TSS) and glycine betaine (GB), in the treated plants, both under normal conditions and under conditions of different degrees of salinity (SSWN<NSWS<SSWS), with values between 35 to 140% higher than the corresponding control groups. Clearly, improving or maintaining photosynthesis systems, which is where CO₂ fixation and carbohydrate synthesis occur, also positively affects sugar production.

Finally, a fifth aspect to highlight is that as a consequence of a greater accumulation of pigments, particularly carotenoids, the greater accumulation of sugars and GB, and relevantly, the lower accumulation in tissues (root and leaves) of Na⁺, there is a clear mitigation of oxidative, osmotic and saline stress respectively, demonstrated through lower values of practically all the different stress indicators (PRO, MDA, H₂O₂, SOD, CAT and GR) in treated plants, compared to the corresponding controls.

### Example 4. Effect of a Polyphenol (Pp) Formula with Glycine Betaine (Gb) And Glycine Betaine Alone in the Management of Salinity Stress on Productive Parameters Of Corn (Zea mays L.)

The test was carried out on the farm located in Hacienda Humboldt (Julimes, Mexico) on an area of 20 hectares, whose soil presented salinity problems (9.11 dS m−1 of electrical conductivity (EC) determined from a 1:1 ratio extract). Three treatments were carried out with three repetitions each, which included T0: control treatment, using only water; T1: Treatment with a formulation containing between 1 to 2% (gallic acid equivalents/100 ml sample) of PP and 2 to 4% GB (w/V), 3 L/Ha; and T2: Treatment with a formulation containing 1 to 2% (gallic acid equivalents/100 mL of sample) of PP. 3 L/ha of each of the formulations were used, which were applied directly to the furrow using equipment with a boom and a Streamjet TP0001-SS nozzle at 2 bars of pressure and with a flow rate of 1,152 L/ha. Applications were made at stages V1, V4 and V6 (16, 32 and 44 days after sowing) of crop development.

For each of these treatments, the ears of corn were harvested from a 30-meter row, fresh weight parameters were measured from 20 randomly selected ears of corn, and the kernels contained in the 20 ears were dried and weighed.

The results showed the following: for the fresh weight of the 20 ears, the highest average was T1 at 55,733 g, followed by T2 at 47,650 g; and the lowest was TO at 39,566 g, all with statistically significant differences (p<0.05). For dry weight per grain, the highest mean was T1 at 0.71 g, followed by T2 at 0.62 g; and the lowest was TO at 0.52 g, all with statistically significant differences (p<0.05).

Based on the results, it was determined that both PP alone and PP co-formulated with GB have an effect on grain yield in corn, observing a synergistic effect between the components of the formulation.

### Example 5. Effect of Biostimulation of the Root System of a Product Based on a Concentrate of Pp and Gb on the Increase in Yield Due to the Effect Of Biostimulation On The Root System Of Basil (Ocimum basilicum) In Greenhouse Conditions

The trial was conducted in the greenhouses of a Green Mex agricultural company located in the town of Axochiapan (Morelos, Mexico). To evaluate the yield of export-quality foliage through biostimulation under poor water quality conditions (EC 15.2 dS*m⁻¹), was carried out in a 1,000 m² greenhouse building, which was divided into 6 plots to establish a total of 2 treatments with 3 repetitions each, these being: T0, for control; and T1, for treatment with a formulation containing 1 to 2% (gallic acid equivalents/100 ml of sample) of PP and 2 to 4% of GB (w/v), with 3 applications of 3 L/ha each every 15 days.

The treatment was applied during the last irrigation of the day by injection in the last third of the irrigation time, ensuring that the product was fully applied. The irrigation system consists of irrigation tapes, emitters every 20 cm and a flow rate of 1.1 L/hour, placed every 60 cm.

From a total of 7 cuts, the number of boxes harvested per treatment was counted (sum of the 3 repetitions). The plots treated with the formulation generated a better yield with an average difference of 65 boxes per 500 m², i.e. an increase of 8.3% in the number of export-quality boxes of basil leaves.

### Example 6. Biostimulation For The Management Of Saline Stress In The Yield Of Jalapeño Pepper Crop Through Root Application of a PP and GB Formula

The trial was carried out at the Invernaderos Yucatan agricultural farm, located in the town of Jiménez (Chihuahua, Mexico) on an area of 3.72 hectares, divided into two irrigation sectors of 1.56 (sector 1) and 2.15 hectares (sector 2). The soil used presented salinity problems (11.19 dS*m−1 of electrical conductivity (EC) determined from a 1:1 ratio extract. For each treatment, 5 blocks of 6 plants were randomly marked for evaluation.

Three applications of a formulation containing 1 to 2% (gallic acid equivalents/100 mL of sample) of PP and 2 to 4% of GB (w/v) were made; each application used 3 L/Ha of the formulation, applied with a boom unit with 16 nozzles for SJ7 liquid fertilizers and a flow rate of 1,230 L/ha, sprayed through the irrigation system, aiming to position the active ingredients between 5 and 30 cm, the area where the highest proportion of roots is found. To evaluate the biostimulant effect of the formulation on the yield and quality of the jalapeño pepper crop, Orizaba variety, the stem thickness (mm) was measured; the leaf area index, AIF (cm²); plant height (mm); and yield (number of fruits/plant).

At the end of the season, there was a 25.7% increase in the average number of fruits per plant; a 7.14% increase in average stem thickness; a 3% increase in average leaf area index; and a 3.9% increase in average plant height. However, significant differences were only observed between the control and treatment groups in the variable number of fruits.

### Example 7. Effect of the Application of a Root Biostimulant Formulated With Polyphenols (Pp) and Glycine Betaine (Gb) on the Increase in Yield in Mexican Lemon (Citrus aurantifolia) Under Conditions Of High Levels Of Bicarbonate

The experiments were carried out under field conditions at the Green Mex company's farm located in the town of Buena Vista de Tomatlán (Michoacán, Mexico).

To evaluate the effect on stress produced by high bicarbonate levels (183 mg/L), two treatments were established (control treatment and treatment with a formulation containing between 1 to 2% (gallic acid equivalents/100 ml of sample) of PP and 2 to 4% of GB (w/v); on 2 rows, where 15 homogeneous trees were selected for each treatment, from which 20 random fruit samples were obtained (5 fruits for each of the 4 sides of the tree). Productivity was measured in terms of average fruit weight (g/fruit) and average juice content (mL/fruit).

The application of the treatment containing PP and GB was carried out via irrigation, injecting directly onto the row line the dose corresponding to 3 L/Ha, which meant an expenditure of 3.6 mL of the formulation per tree and for the row it meant injecting 76 mL (1.35 mL/linear meter) in the last third of irrigation. The first application was made at full bloom, the second with fruit between 5 to 10 mm, the third with fruit between 14 to 20 mm, and the last with fruit>30 mm.

The effect of the application corresponded to a 5.11% increase in fresh weight per fruit and a 9.6% increase in juice content per fruit.

### Example 8. Saline Stress Management Through a Formula Containing Pp And GB and its Effect on the Yield of the Onion Crop, Blanca Montejo Variety

The trial was conducted at the Agrolosa agricultural farm, located in the town of Lázaro Cárdenas (Chihuahua, Mexico), on an area of 5 hectares, divided into two irrigation sectors. The soil used had an EC of 13.8 dS*m⁻¹ determined from a 1:1 ratio extract, which is considered saline. Three applications were made every 15 days, of 3 L/h each, applied using a bar equipment with nozzles for SJ7 liquid fertilizers and a flow rate of 1,536 L/ha, of a formulation containing between 1 to 2% (equivalents of gallic acid/100 ml of sample) of PP and 2 to 4% of GB (w/v). For both the control group (TO) and the treated group (T1), 15 plants were marked and harvested from 3 blocks randomly arranged in each sector.

At the end of the season, an increase of 1.33% in onion yield was obtained (TO: 94,644 and T1: 95,904 Kg/ha). Although no significant differences were observed in terms of yield, there was a significant improvement in the size of the bulbs, corresponding to an average value of 7.41 inches for TO and 8.17 inches for T1 (10.26% increase), which translates into a price differential due to the quality and classification corresponding to these sizes.

### Example 9. Effect of Root System Biostimulation of a Product Based on A Formula of Polyphenols (PP) and Glycine Betaine (GB) on the Increase in Asparagus Yield (Asparagus officinalis)

The trial was carried out in the agricultural area in the town of Ica, Peru. The crop has a plant density of 19,000 units per hectare, irrigated by means of a tape with well water with a high concentration of salts (EC 21.3 dS*m⁻¹).

To evaluate the yield of shoots, the number of 5 kg boxes with A and B quality and XL size was measured during a cutting cycle lasting 6 days, 1 hectare per sector. Two sectors of 1 Ha each were available, corresponding to T0 for the control sector and T1 for the sector treated via foliar application with a formulation containing between 1 to 2% (equivalents of gallic acid/100 ml of sample) of PP and 2 to 4% of GB (w/v), at a dose of 3 L/Ha and a wetting of 650 L/Ha. Applications were made with the first, second and third outbreak with the same doses of 3 L/Ha each.

From a total of six harvests, the number of boxes harvested per treatment was counted. The control sector yielded 631 boxes, equivalent to 3,155 kg; and the treated sector yielded 714 boxes, equivalent to 3,570 kg. This represents a 13% increase in yield for the treated sector.

According to the examples provided, clearly the formulation of polyphenols (PP) and glycine betaine (GB) provides a novel and unique method to mitigate abiotic stress, particularly one of the most complex ones such as salinity stress, by comprehensively and effectively reducing oxidative stress, osmotic stress and ionic stress, triggered by excess salts.

1. A method for extracting an active acid extract from agricultural husks, particularly rice husks, where the active acid extract is obtained through the following phases:
a) Pentose extraction phase,
b) Oxidation phase,
c) Clarification and concentration phase,
d) Adsorption or retention phase,
e) Purification phase and
f) Desorption phase;
characterized because in the d) adsorption and concentration phase, the filtered or clarified and concentrated product resulting from the classification and concentration phase is circulated through columns packed with 1 to 4 kg, preferably 1.5 to 3 kg of granular activated carbon or a quantity of high specific adsorption capacity resin that can be packed in a volume equivalent to the effective volume of the columns given by an internal diameter of 10.16 cm and an effective height of 85 cm. The selected resins with a high specific adsorption capacity are included in the group of macroporous polystyrene resins functionalized with tertiary amines, such as Purolite® MN-102, or with other hydrophilic molecules, or resins from the amberlite family; applying an optimal influent flow rate between 1.0 to 6.0, preferably between 1.5 to 4.5 PBV h−1 (packed bed volumes per hour) for the development and inclusion of an adsorption process so that phenolic compounds and flavonoids contained in low concentrations in the clarified and concentrated product and circulated as influent in the columns, are adsorbed and retained in the adsorbent material; while other secondary compounds, such as aliphatic polyhydroxycarboxylic acids, carbohydrates, alcohols and aldehydes, are eliminated in the effluent; in the e) purification phase the columns containing the phenolic compounds and flavonoids adsorbed on the activated carbon or high specific adsorption capacity resins are washed in counterflow with 5 to 50 L, preferably with 15 to 30 L of acidified water (pH<4), to eliminate other residual compounds, such as aliphatic polyhydroxycarboxylic acids, carbohydrates, alcohols and aldehydes, absorbed between the pores of the activated carbon or macroporous resins that could act as contaminants during the desorption or elution process. Additionally, and to facilitate the subsequent desorption or elution process, the columns are drained of the washing water and dried by means of counterflow air circulation for 5 to 30 minutes, preferably for 10 to 20 minutes, and in the f) desorption phase 10 to 40 L, preferably 15 to 25 L of 96% (v/v) ethanol or an alkaline aqueous solution of potassium hydroxide 0.05 to 0.2 M, preferably 0.1 to 0.2 M, are circulated in counterflow through the columns packed with the adsorbed polyphenolic compounds, maintaining the pH in a range of 7.0 to 10, preferably between 7.5 to 9.0, to favor the solubility of the adsorbed compounds and facilitate the desorption or elution process to obtain a concentrated active acid extract with polyphenols in a concentration range between 3 to 10 g equivalent of gallic acid/100 mL

2. The method of claim 1, wherein the active acid extract, is formulated at a concentration of 3 to 10 g equivalent of gallic acid/100 mL together with glycine betaine until reaching a final concentration between 0.5 to 2.5% g equivalent of gallic acid/100 g of sample, preferably between 1.0 to 2.0%, while the GB is at a concentration between 1 to 5%, preferably between a concentration between 2 to 3%, maintaining a polyphenols (PP)/glycine betaine (GB) ratio between 1:1 to 1:3.

3. The method of claim 2, characterized in that it is applied for the treatment of plants, when diluted in water until reaching final concentrations of effective field doses of 0.0014 to 0.0105% (w/v) of polyphenols (PP) and 0.0030 to 0.0225% of glycine betaine (GB), applying between 400 to 1000 L/Ha of the diluted solution.

4. The method of claim 2, characterized in that it is used to promote the growth and development of plants under normal conditions or under abiotic stress, particularly under salinity stress, and comprising the application of effective doses of the solution to monocotyledonous plants, such as a cereal or grass, preferably corn, or to an amaryllidaceae, preferably onion; and dicotyledons of the Solanaceae family, preferably tomato, chili, pepper and potato, or of the Rosaceae family, preferably apple, or of the Malvaceae family, preferably cotton, or of the Cucurbitaceae family, preferably watermelon, melon or cucumber, or of the Asparagaceae family, preferably asparagus.

5. The method of claim 2, characterized in that it is used to promote the overexpression of genes involved in the response to oxidative stress, such as APX, ascorbate peroxidase; GST1, glutathione S-transferase-1; ion transport, such as ATPse4 and ATPase4; auxin transport, such as PIN1 and PINFORMED; and response to auxins, such as IAA5 and Inducible Indole-3-acetic Acid 5 under normal conditions or under abiotic stress, particularly under salinity stress, and comprising the application of effective doses of the solution to monocotyledonous plants, such as a cereal or grass, preferably corn, or to an amaryllidaceae, preferably onion; and dicotyledons of the Solanaceae family, preferably tomato, chili, pepper and potato or of the Rosaceae family, preferably apple, or of the Malvaceae family, preferably cotton, or of the Cucurbitaceae family, preferably watermelon, melon or cucumber, or of the Asparagaceae family, preferably asparagus.

6. The method of claim 2, characterized in that in the case of cereals, such as corn, it is applied during the vegetative stage of growth, starting at V2 and ending at VT, at a concentration of 1 to 3 L/Ha, divided into 2 to 3 applications; in the case of apple crops, between 1 to 5 L per hectare are applied, preferably 2 to 4 L per hectare, divided into 3 applications, starting after the sprouting period and at intervals of 20 to 30 days; for the cultivation of vegetables, such as asparagus, chili, tomato and onion, the same concentration is applied divided into 3 applications, starting after the sprouting period and at intervals of 15 to 20 days, while in cotton crops, in a single application, of the same concentration after the sprouting period.

7. The method of claim 2, characterized in that it is applied with a herbicide, such as glyphosate, halosulfuron, or others; a fungicide, such as strobirulins, tetraconazole, or others; with a nematicide, such as strobirulins, tetraconazole, or others; and with nitrogen fertilizers, such as ammonium nitrate, potassium nitrate, urea, or micronutrients.

8. The method of claim 2, characterized in that it is applied directly to the soil by any convenient means, including sprinkling, drip irrigation systems, tape irrigation systems.
